(19) United States
(12) Patent Application Publication
(10) Pub. No.: US 2012/0154857 A1
(43) Pub. Date: Jun. 21, 2012

(54) INFORMATION PROCESSING APPARATUS, PRINTING CONTROL METHOD, AND STORAGE MEDIUM THEREFOR

(75) Inventor: Yoichi Matsuyama, Yokohama-shi (JP)

(73) Assignee: CANON KABUSHIKI KAISHA, Tokyo (JP)

(21) Appl. No.: 13/308,830

(22) Filed: Dec. 1, 2011

(30) Foreign Application Priority Data
Dec. 15, 2010 (JP) 2010-279500

(51) Int. Cl. G06F 3/12

(52) U.S. Cl. 358/1.15

(57) ABSTRACT

A printing control method includes obtaining, from a control unit controlling printing of print data, identification information for identifying an image forming apparatus connected to the control unit and model information indicating a model of the image forming apparatus, storing the identification information and the model information associated with control unit identification information for identifying the control unit into a storage device, receiving the print data and the identification information from an interface unit for transmitting the print data and the identification information of the image forming apparatus in response to a request from an application unit, and reading out, from the storage device, the received control unit identification information in association with the identification information, and determining the control unit identified by the control unit identification information as a control unit to be specified to control printing of the print data.

### BACKGROUND OF THE INVENTION

1. Field of the Invention

The present invention relates to an information processing apparatus, a printing control method, and a storage medium therefor.

2. Description of the Related Art

To instruct a printer to perform printing, a client application generally specifies a printer driver corresponding to the type of the printer, and sets information for the printing. In this case, for each of printers of different types, the client application performs the same processing for each printer.

On the other hand, a client application that uses its own user interface (UI) instead of a UI provided by a printer driver needs to perform different processes for each of printers of different types. In this case, processing is performed for each printer using a Software Development Kit (SDK) of a printer driver provided for each printer or an SDK for connection that does not use a printer driver. Accordingly, modification of the program is required to perform printing using a new printer.

In a case where a client application uses a plurality of printers, a printer driver that converts a data format to another processable format by each of the printers or a personal computer (PC) running an SDK thereon is under higher load. However, there has not been provided an approach to distribute the load.

Japanese Patent Application No. 5-274095 discusses a method of accommodating differences in printer types, in which a common command to control printers is converted to a control command unique to each printer by referring to feature information of the printer. Japanese Patent Application No. 8-123638 discusses a method of generating print data by dividing functions of a printer into separate components, and combining the components.

In the method of Japanese Patent Application No. 5-274095, however, when a printer having a new function is used, an additional processing procedure of the control commands to handle the new function is required.

In the method of Japanese Patent Application No. 5-274095, to realize printing unique to the function of a specific printer, preparation of print data is required to selectively incorporate the function supported by the printer. Furthermore, in the above method is used, a print control apparatus needs to be entirely modified to handle a new printer.

### SUMMARY OF THE INVENTION

The present invention is directed to an information processing apparatus capable of printing in a new printer easier.

According to an aspect of the present invention, an information processing apparatus includes a storage unit having a storage device, configured to obtain, from a control unit, identification information for identifying an image forming apparatus connected to the control unit and model information that indicates a model of the image forming apparatus, and to store the identification information and the model information in association with control unit identification information that identifies the control unit, into the storage device, wherein the control unit controls printing of print data, a receiving unit configured to receive the print data and the identification information from an interface unit, wherein an application unit generates job information in a format in which print setting information indicating a setting item of the image forming apparatus for printing the print data and a value of the setting item can be added, and to request for transmission of the print data and the identification information of the image forming apparatus, wherein the interface unit transmits, upon receiving the request, the print data and the identification information of the image forming apparatus therethrough, and a determination unit configured to read out, from the storage device, the control unit identification information that is associated with the identification information, and received by the receiving unit, and to determine the control unit identified by the control unit identification information as a control unit to be specified to control printing of the print data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a print control system.

FIG. 2 is a block diagram illustrating a hardware configuration of a personal computer (PC).

FIGS. 3A and 3B illustrate a screen, and a file containing the values set via the screen, respectively.

FIGS. 4A and 4B illustrate a screen, and a file containing the values set via the screen, respectively.

FIGS. 5A and 5B illustrate a screen, and a file containing the values set via the screen, respectively.

FIG. 6 illustrates a flowchart for search and registration processing.

FIG. 7 illustrates an example of a screen.

FIG. 8 illustrates an example of a search result.

FIG. 9 illustrates an example of a screen.

FIG. 10 illustrates an example of a printing apparatus management table.

FIG. 11 illustrates an example of a printing apparatus control module management table.

FIG. 12 illustrates an example of a printing apparatus management table.

FIG. 13 illustrates an example of a screen.

FIGS. 14A and 14B respectively illustrate examples of status information and a path used to obtain the information.

FIG. 15 illustrates an example of a status path management table.

FIG. 16 illustrates an example of a status path management table.

FIG. 17 illustrates an example of a flowchart for print processing.

FIG. 18 illustrates an example of a ticket.

FIG. 19 illustrates an example of a ticket.

FIG. 20 illustrates an example of a path, and data obtained based on the path.

### DESCRIPTION OF THE EMBODIMENTS

Various exemplary embodiments, features, and aspects of the invention will be described in detail below with reference to the drawings.

The following exemplary embodiments are not intended to limit the present invention, and the structures and configurations of the exemplary embodiments are not necessarily essential for the methods of the present invention for solving the above described problems.

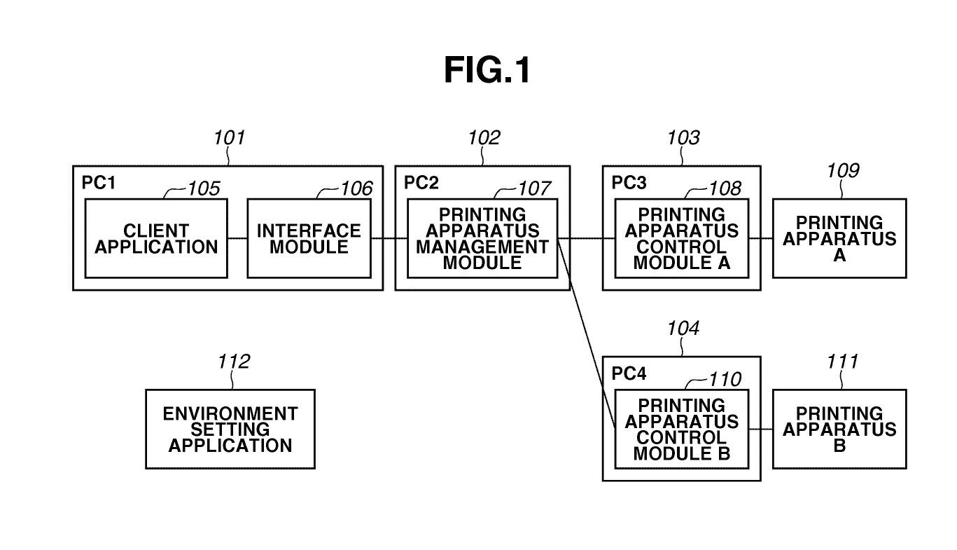

FIG. 1 illustrates a configuration of a print control system according to the present exemplary embodiment. The print control system includes a PC1 (101), a PC2 (102), a PC3 (103), and a PC4 (104) as examples of information processing apparatuses (computers).

The PC1 (101) is a device where a client application 105 runs, and the client application 105 is an example of an application unit. The client application 105 uses a print control system via an application programming interface (API). The API is provided by an interface module 106 that is included in the print control system.

The PC2 (102) is a device where a printing apparatus management module 107 runs, which is an example of a management unit. The printing apparatus management module 107 responses to a request transmitted from the client application 105 through an interface module 106 that is an example of an interface unit, and processes the request.

The printing apparatus management module 107 transfers the request to a printing apparatus control modules (108, 110). The printing apparatus control modules (108, 110) each are an example of a control unit that responds to a printing apparatus specified at the transfer of the request. When an event occurs at printing apparatuses (109, 111), the printing apparatus management module 107 transmits the event information to the client application 105 through the respective printing apparatus control modules (108, 110) and through the interface module 106.

Thus, the printing apparatus management module 107 manages information that indicates relationships between the client application 105, one or more printing apparatuses used by the client application 105, and one or more printing apparatus control modules that control the printing apparatuses respectively.

The printing apparatus management module 107 further manages information that indicates relationships between specification information and the client application 105 that sets the specification information. The specification information is set by the client application 105 using API to specify a target to which a change in status of a printing apparatus is notified.

In the present exemplary embodiment, the communication between the printing apparatus management module 107 and the printing apparatus control modules (108, 110) is common to printing apparatus control modules of any type. Accordingly, a new printing apparatus can be supported by adding a printing apparatus control module corresponding to the new printing apparatus to form a plug-in connection therebetween.

The PC3 (103) is a device where the printing apparatus control module A 108 runs, and the PC4 (104) is a device where the printing apparatus control module B 110 runs.

The printing apparatus control module A 108 and the printing apparatus control module B 110 individually process a request transmitted from the printing apparatus management module 107. The printing apparatus control module A 108 controls the printing apparatus A 109 to perform printing, and performs processing to change setting information of the printing apparatus A 109. The printing apparatus control module B 110 controls the printing apparatus B 111 to perform printing, and performs processing to change setting information of the printing apparatus B 111.

The printing apparatus A 109 notifies the printing apparatus control module A 108 of a change in the status of the printing apparatus A 109. The printing apparatus B 111 notifies the printing apparatus control module B 110 of a change in the status of the printing apparatus B 111.

Thus, the printing apparatus control modules (108, 110) individually manage specification information that specifies a target to which a change in the status, which is set by the client application 105 using API, of the printing apparatuses (109, 111) is individually notified.

In the present exemplary embodiment, the printing apparatus A 109 and the printing apparatus B 111 each are an example of an image forming apparatus, and are of different types. More specifically, printing apparatus A 109 and the printing apparatus B 111 maybe single function printers (SFPs) or multi function printers (MFPs) of different types, for example.

The environment setting application 112 sets information about the environment of the print control system. More specifically, the environment setting application 112 sets operation parameters (operation setting information) of a module running on a started-up PC, and information (connection setting information) about communication between the module and other modules connected thereto. The environment setting application 112 can run on each of the PC1 (101), the PC2 (0102), the PC3 (103), and the PC4 (104).

Starting up of each module in the print control system is described. The order of the start-up may be different from that described below except the order of the interface module 106.

The printing apparatus management module 107 is mounted as a resident process unit in an operation system (OS) running on the PC2 (102). In other words, the printing apparatus management module 107 is mounted as a service unit of the OS.

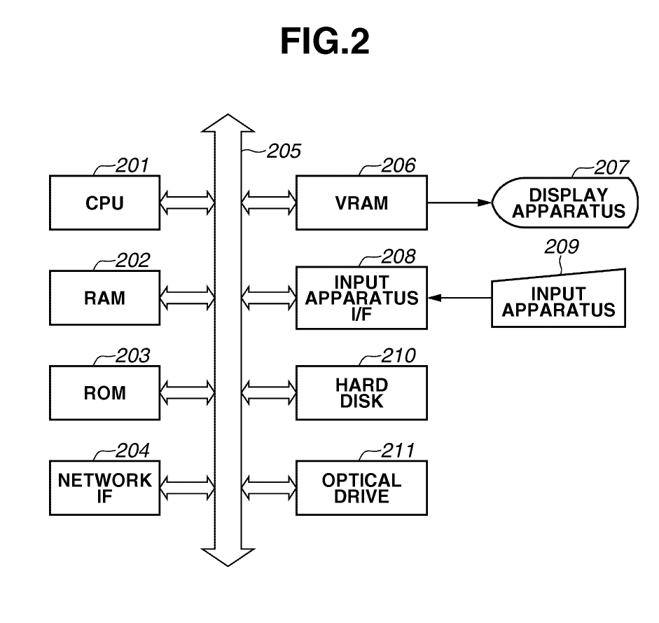

FIG. 2 is a block diagram illustrating a hardware structure of the PC2 (102). The PC2 (102) includes a central processing unit (CPU) 201, a random access memory (RAM) 202, a read only memory (ROM) 203, a network I/F 204, a bus 205, a video random access memory (VRAM) 206, an input apparatus I/F 208, a hard disk 210, and an optical drive 211. Each of these units is connected to be capable of communicating with one another via the bus 205.

The CPU 201 controls the PC2 (102) entirely according to a control program read in the RAM 202. The RAM 202 temporarily stores various data. The ROM 203 stores (holds) various data. The network I/F 204 transmits/receives print data and requests to/from the other PCs such as the PC1 (101), the PC3 (103), and the PC4 (104) through a network.

The VRAM 206 holds various information to be displayed on a display apparatus 207 that is a liquid crystal display for example. The input apparatus I/F 208 is connected to an input apparatus 209 such as a mouse and a keyboard for example, and processes information input from users through an input apparatus driver.

The hard disk 210 stores programs for the printing apparatus management module 107, and also stores various data such as tables and print data. The optical drive 211 reads a medium such as DVD to read out data such as a program for the printing apparatus management module 107 from the medium to be installed to the PC2 (102), and to store (backup) various data into the DVD.

In the present exemplary embodiment, the printing apparatus management module 107 (service unit) is automatically started up upon start-up of the PC2 (102). More specifically, when the PC2 (102) is started up, a program for the printing apparatus management module 107 is read out to the RAM. 202 from the hard disk 210, and the CPU 201 interprets and executes the program to start up the printing apparatus management module 107. The printing apparatus management module 107 is thereafter resident thereinto operate, unless a failure occurs or an explicit operation to end the module 107 is executed.

The PC1 (101), the PC3 (103), and the PC4 (104) each have the same hardware structure as that of the PC2 (102).

The printing apparatus control module A 108 and the printing apparatus control module B 110 are respectively mounted on the PC3 (103) and the PC4 (104) as a service unit, as in the case with the printing apparatus management module 107. The printing apparatus control module A 108 and the printing apparatus control module B 110 are automatically started up respectively when the PC3 (103) and the PC4 (104) are started up.

Start-up of the printing apparatus control module A 108 is described in detail below. The printing apparatus control module B 110 is started up similarly.

The printing apparatus control module A 108 (service unit) is automatically started up when the PC3 (103) is started up. More specifically, upon starting up of the PC3 (103), a program for the printing apparatus control module A 108 is read out from the hard disk 210 to the RAM 202, and the program is interpreted and executed by the CPU 201, which starts up the printing apparatus control module A 108. The printing apparatus control module A 108 is thereafter resident therein to operate, unless a failure occurs or an explicit operation to end the printing apparatus control module A 108 is executed.

The printing apparatus control module A 108 establishes a connection with the printing apparatus management module 107, based on below-described connection setting information. If the printing apparatus management module 107 is not started up yet at starting up the printing apparatus control module A 108, the printing apparatus control module A 108 attempts repeatedly to establish connection with the printing apparatus management module 107 at predetermined intervals and/or predetermined times.

If the printing apparatus control module A 108 cannot establish connection with the printing apparatus management module 107 after the attempts, an error message is displayed to end the process for start up.

Each module of the print control system is required to have, before usage, its own operation setting information and connection setting information to be connected to the other modules. Both of the operation setting information and the connection setting information are set using the environment setting application 112.

The setting information of the interface module 106 is set as follows. First, a user of the print control system starts up the environment setting application 112 on the PC1 (101) where the interface module 106 runs.

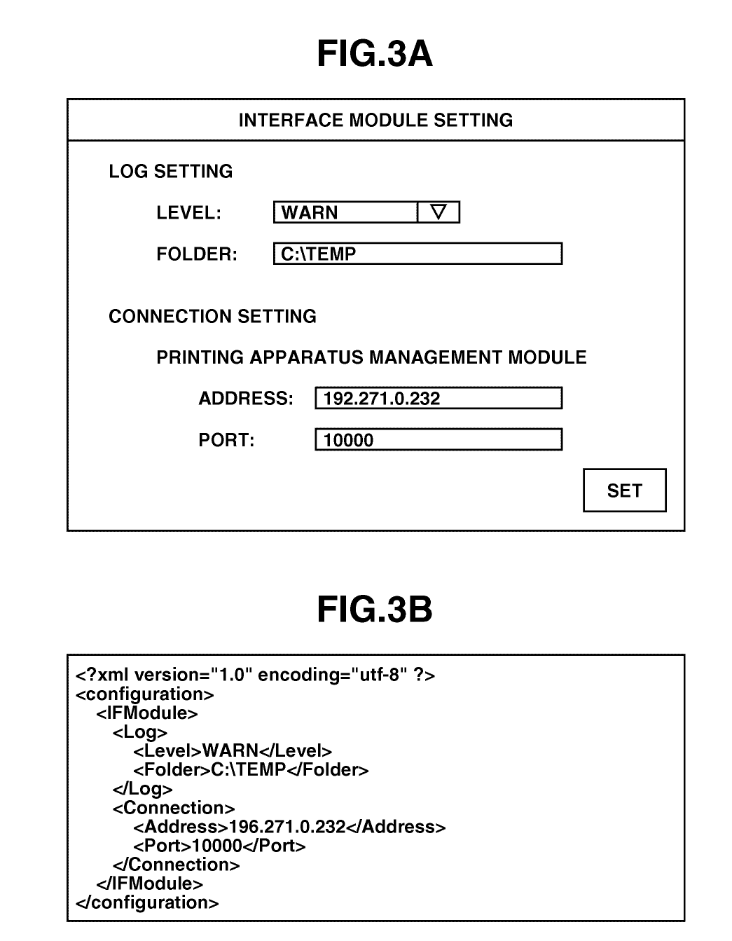

As illustrated in FIG. 3, the information set for the interface module 106 includes log setting information that is used to output a log. The log setting information contains setting items such as a log level and a log folder. In FIG. 3, the log level is set as “WARN”, and the log folder is set as “TEMP”.

The setting information set for the interface module 106 further includes connection setting information to connect between the interface module 106 and the printing apparatus management module 107. The connection setting information contains setting items such as an address and a port number of the connection destination.

The user then specifies a log level, a log folder, and an address and a port number of the printing apparatus management module 107 as a connection destination, through a user interface provided by the environment setting application 112.

FIG. 3A illustrates a user interface (screen) provided by the environment setting application 112. A user specifies a value for each of the setting items, and presses down the setting button displayed on the screen in FIG. 3A (i.e., an operation of the input apparatus 209 by a user). The specified information is stored in the hard disk 210 of the PC1 (101), as an XML file illustrated in FIG. 3B for example.

In the present exemplary embodiment, the XML file is read out from the hard disk 210 and the set information is reflected when the interface module 106 is started up on the PC1 (101).

In the present exemplary embodiment, in the XML file in FIG. 3B, the log setting information is used as the values for Level tag and Folder tag in Log tag, and the connection setting information to the printing apparatus management module 107 is used as the values for Address tag and Port tag in Connection tag.

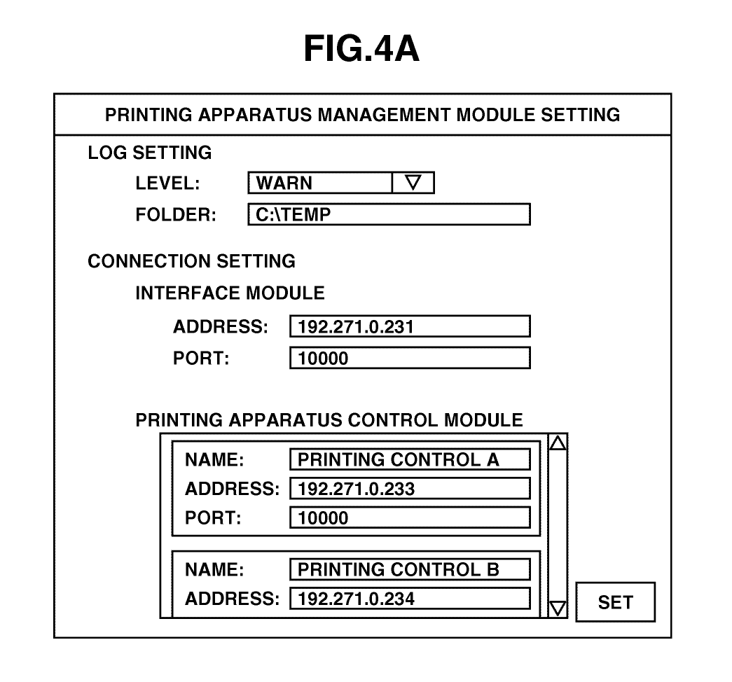

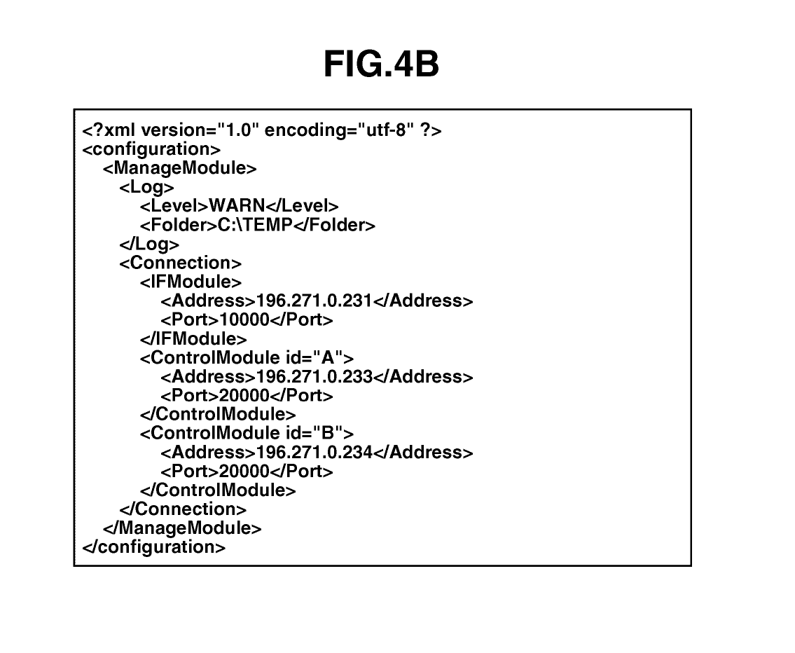

As illustrated in FIGS. 4A and B, the information set for the printing apparatus management module 107 includes log setting information. The log setting information contains setting items such as a log level and a log folder. In FIGS. 4A and 4B, the log level is set as “WARN”, and the log folder is set as “TEMP”.

The setting information of the printing apparatus management module 107 further includes connection setting information about the connection between the printing apparatus management module 107 and the other modules. The connection setting information contains setting items such as an address and a port number of the respective connection destinations.

The printing apparatus management module 107 is connected to the interface module 106, the printing apparatus control module A 108, and the printing apparatus control module B 110 for transmitting/receiving various information therebetween.

A user then specifies a log level, a log folder, and an address and a port number of a module that is a connection destination, through a user interface provided by the environment setting application 112.

FIG. 4A illustrates an example of a user interface (screen) provided by the environment setting application 112. A user specifies a value for each of the setting items, and presses down the setting button displayed on the screen in FIG. 4A. The specified information is stored in the hard disk 210 of the PC2 (102), as an XML file illustrated in FIG. 4B for example. In the present exemplary embodiment, the XML file is read out from the hard disk 210 and the set information is reflected when the printing apparatus management module 107 is started up on the PC2 (102).

In the XML file in FIG. 4B, the log setting information is used as the values for Level tag and Folder tag in Log tag.

The connection setting information to the interface module 106 is used as the values for Address tag and Port tag in IFModule tag. The connection setting information to the printing apparatus control module A 108 is used as the values for Address tag and Port tag in ControlModule tag where the attribute id is “A”.

The connection setting information to the printing apparatus control module B 110 is used as the values for Address tag and Port tag in ControlModule tag where the attribute id is “B”.

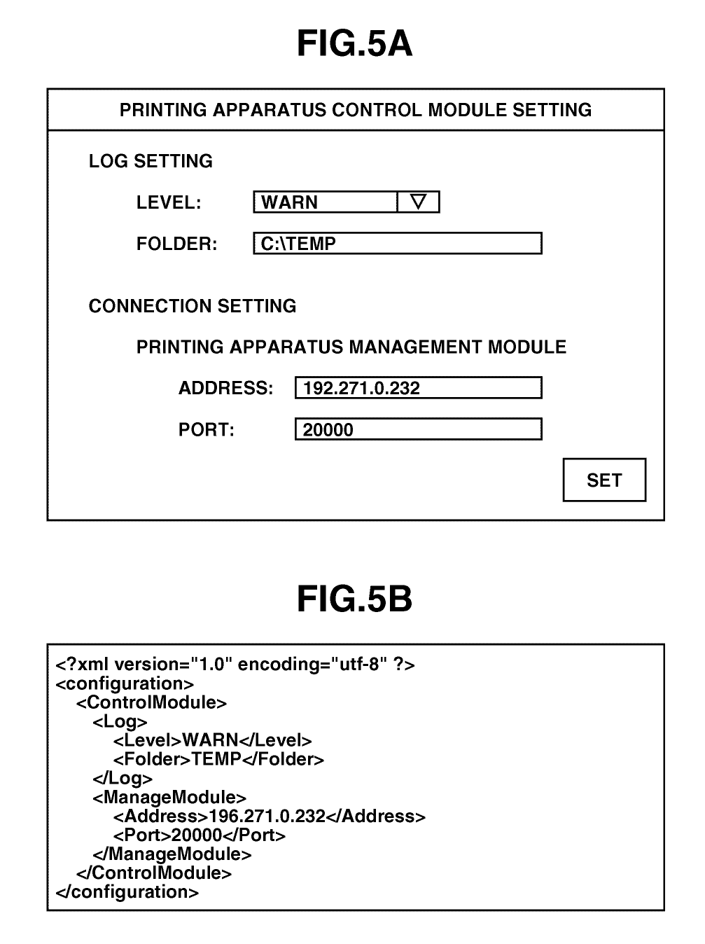

As illustrated in FIGS. 5A and 5B, the information set for the printing apparatus control module A 108 includes log setting information. The log setting information contains setting items such as a log level and a log folder. In FIGS. 5A and 5B, the log level is set as “WARN”, and the log folder is set as “TEMP”.

The setting information of the printing apparatus control module A 108 further includes connection setting information to connect the printing apparatus control module A108 and the other modules. The connection setting information contains setting items such as an address and a port number of the connection destinations. The printing apparatus control module A 108 is connected to the printing apparatus management module 107 for transmitting/receiving of various information therebetween.

A user then specifies a log level, a log folder, and an address and a port number of the printing apparatus management module 107 that is a connection destination, through a user interface provided by the environment setting application 112.

FIG. 5A illustrates an example of a user interface (screen) provided by the environment setting application 112. A user specifies a value for each of the setting items, and presses down the setting button displayed on the screen in FIG. 5A. The specified information is stored in the hard disk 210 of the PC3 (103), as an XML file for example.

In the present exemplary embodiment, the XML file is read out from the hard disk 210 and the set information is reflected when the printing apparatus control module A 108 is started up on the PC3 (103).

In the XML file in FIG. 5B, the log setting information is used as the values for Level tag and Folder tag in Log tag. The connection setting information to the printing apparatus management module 107 is used as the values for Address tag and Port tag in ManageModule tag.

The setting information of the printing apparatus control module B 110 is set in a similar manner to that for that of the printing apparatus control module A 108.

According to the above described configuration, setting information of the printing apparatus management module 107 and the printing apparatus control modules (108, 110) is set using the environment setting application 112, and thereby the print control system can handle a new printing apparatus without changing any other parts of the print control system.

Before the print control system is used, information of a printing apparatus needs to be stored in the printing apparatus management module 107 and the printing apparatus control modules (108, 110). The information enables usage of the printing apparatus in the print control system. This information storage is so-called “registration of printing apparatus”. A method of registering a printing apparatus is described, which includes searching one or more printing apparatuses that can be used in the print control system and registering a printing apparatus that is specified to be used among the searched printing apparatuses.

To accomplish the method, the environment setting application 112 starts to run on the PC2 (102) where the printing apparatus management module 107 is running, to search for the printing apparatuses (109, 111) connected via the printing apparatus control modules (108, 110) respectively.

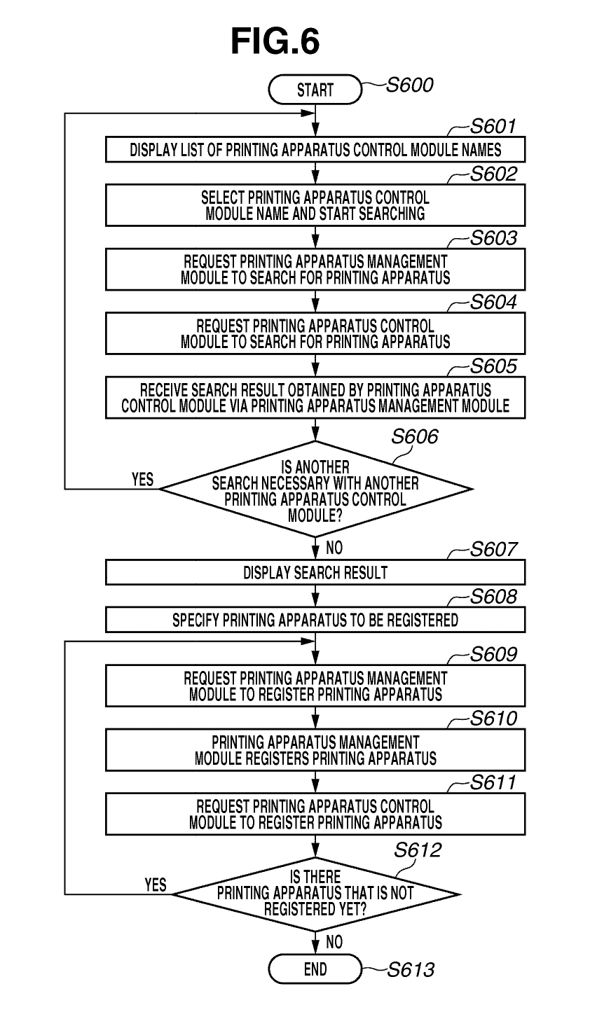

FIG. 6 is a flowchart illustrating a program for search and registration processing in which one or more printing apparatuses are searched for and registered.

In step S600, a search and registration processing starts. In step S601, the environment setting application 112 communicates with the printing apparatus management module 107, to obtain control unit identification information such as identifiers that respectively identify printing apparatus control modules connected to the printing apparatus management module 107, and to display a screen based on the obtained information.

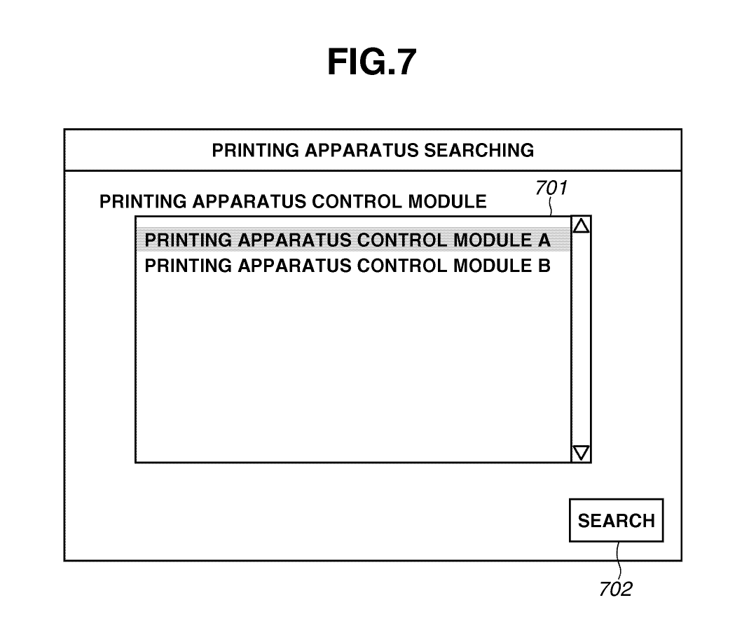

FIG. 7 illustrates a screen (printing apparatus searching screen) displaying a list 701 of names of printing apparatus control modules (printing apparatus control module names).

In step S602, the environment setting application 112 selects a printing apparatus control module name from among the printing apparatus control module names on the printing apparatus search screen, so that a user can input an operation by pressing down a search button 702 to start searching for a printing apparatus.

In step S603, the environment setting application 112 specifies a printing apparatus control module name, and requests the printing apparatus management module 107 to search for the specified printing apparatus.

In step S604, the printing apparatus management module 107 requests the printing apparatus control module corresponding to the specified printing apparatus control module name to search for a printing apparatus. Hereinafter, a case where the printing apparatus control module A 108 is specified through the printing apparatus search screen is described.

In step S605, the environment setting application 112 receives a search result, indicating printing apparatuses which the printing apparatus control module A 108 can control, from the printing apparatus control module A 108. In the present exemplary embodiment, the search result contains information that identifies the printing apparatus A 109, such as a printing apparatus identifier.

Because a plurality of printing apparatuses can be connected to the printing apparatus control module, in this case, the search result contains information such as identifiers that identify the plurality of printing apparatuses respectively.

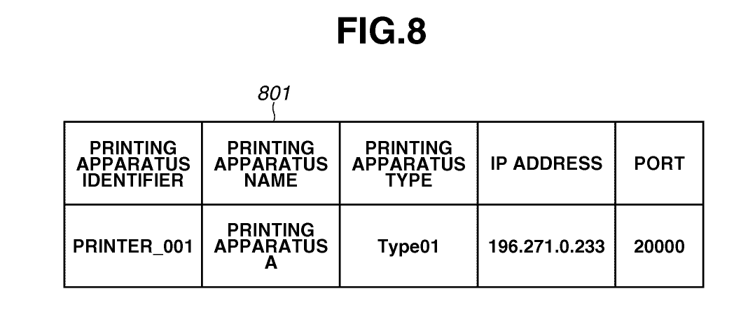

FIG. 8 illustrates a search result (a search result 801). The search result 801 includes only the information of the printing apparatus A 109 as a printing apparatus information table, but in the case where a plurality of printing apparatuses are connected as described above, the search result 801 will contain information of the plurality of printing apparatuses.

The search result 801 contains information regarding a plurality of items. More specifically, the search result 801 contains information regarding a printing apparatus identifier, printing apparatus name, printing apparatus type, IP address, and port. The printing apparatus identifier is an example of identification information that identifies a printing apparatus, and the printing apparatus type is an example of information indicating a type of a printing apparatus (model information indicating a model of an image forming apparatus).

In step S606, the environment setting application 112 displays a screen (not illustrated) to inquire a user whether the user is going to make a search with another printing apparatus control module. When the user instructs a search using another printing apparatus control module (YES in step S606), the process in step S601 is performed. When the user instructs no search using another printing apparatus control module (NO in step S606), the process in step S607 is performed.

In step S607, the environment setting application 112 displays a search result obtained through the printing apparatus control module A 108 and the printing apparatus management module 107, on a screen.

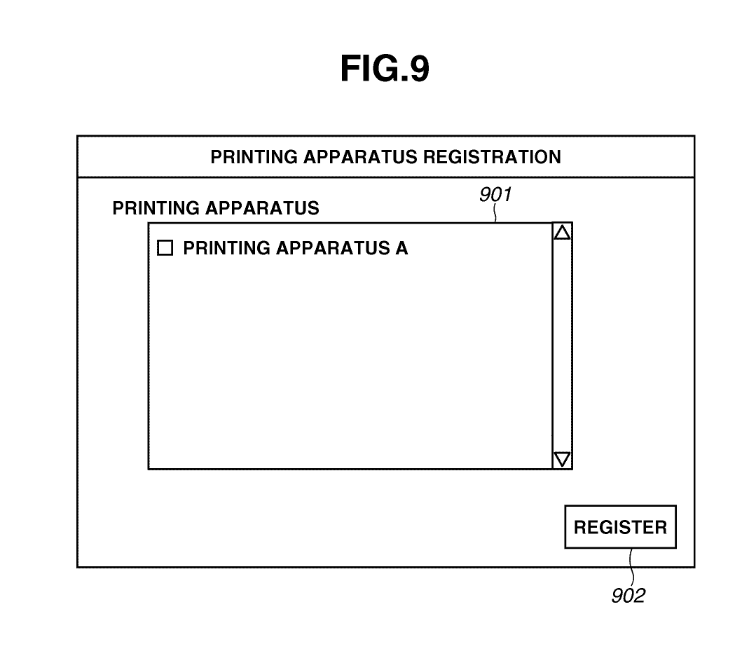

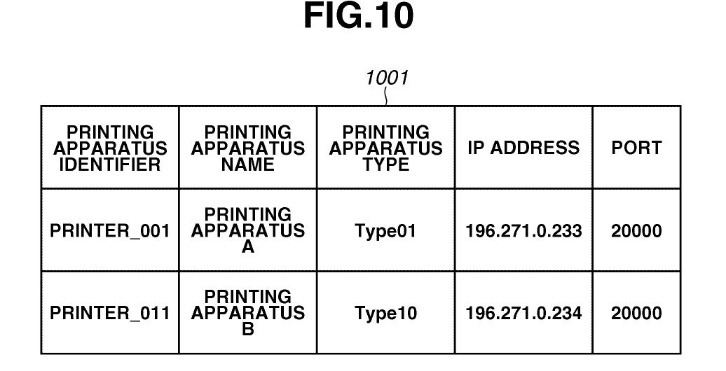

FIG. 9 illustrates an example of a screen (a search result screen) displaying a list of a search result. The search result screen displays a search result list 901 where one or more printing apparatus names (i.e., the value for the printing apparatus name in FIG. 8) are displayed.

In step S608, the environment setting application 112 receives an operation from a user who puts a check mark on each of printing apparatuses the user selects from the search result list 901 and presses down a registration button 902, to start registration of the specified printing apparatus.

In step S609, the environment setting application 112 specifies a printing apparatus with the check mark (more specifically, a corresponding printing apparatus identifier), and requests the printing apparatus management module 107 to register the specified printing apparatus. The request is made for the apparatus at the top of the list among the printing apparatuses that each have a check mark and are not registered yet.

In step S610, the printing apparatus management module 107 adds the information of the printing apparatus corresponding to the specified printing apparatus identifier to the printing apparatus management table in the printing apparatus management module 107.

FIG. 10 illustrates an example of a printing apparatus management table (printing apparatus management table 1001) stored in the hard disk 210 of the PC2 (102).

The printing apparatus management table 1001 stores information regarding printing apparatus identifier, printing apparatus name, printing apparatus type, IP address, and port. The information of printing apparatuses is stored into the printing apparatus management table 1001 by inputting each piece of the information of the printing apparatus corresponding to a specified printing apparatus identifier into the corresponding item of the printing apparatus management table 1001.

After the update of the printing apparatus management table 1001, the printing apparatus management module 107 specifies a printing apparatus identifier of the printing apparatus control module corresponding to the type of a printing apparatus to be registered, and requests for registration of the printing apparatus.

The printing apparatus management module 107 determines a printing apparatus control module to which the printing apparatus management module 107 requests registration, with reference to a printing apparatus control module management table.

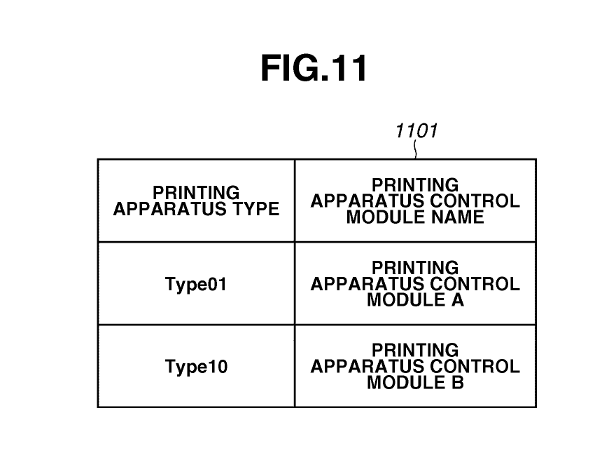

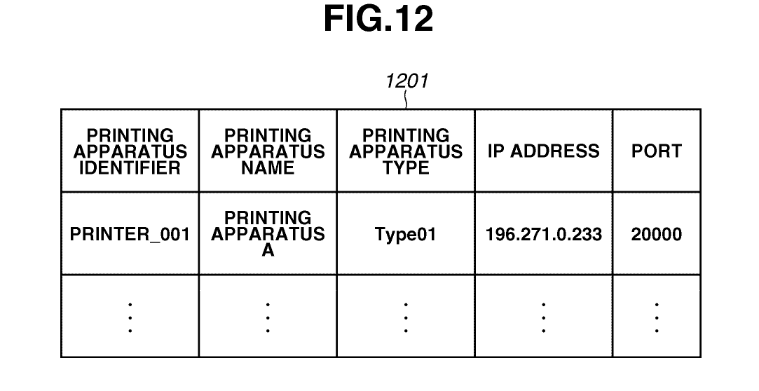

FIG. 11 illustrates an example of a printing apparatus control module management table (a printing apparatus control module management table 1101) that is stored in the hard disk 210 of the PC2 (102). The printing apparatus control module management table 1101 stores information in which printing apparatus types are respectively associated with names of printing apparatus control modules that control the printing apparatuses of the types.

According to the information, a printing apparatus control module, when connected to the printing apparatus management module 107, notifies the module 107 of the type of a printing apparatus to control. The printing apparatus management module 107, upon receipt of the notification, updates the printing apparatus control module management table 1101.

In the present exemplary embodiment, the printing apparatus type of the printing apparatus A is read out from the search result 801, so that the printing apparatus control module A 108 is specified out of the printing apparatus control module management table 1101 as the apparatus module that corresponds to the type and that controls the printing apparatus A.

In step S611, the printing apparatus management module 107 requests the printing apparatus control module A 108 to register the printing apparatus A. In other words, the printing apparatus control module A 108 adds the information of the printing apparatus corresponding to the specified printing apparatus identifier to its own printing apparatus management table.

FIG. 12 illustrates an example of a printing apparatus management table (a printing apparatus management table 1201) stored in the hard disk 210 of the PC3 (103).

In step S612, the environment setting application 112 determines whether there remains a printing apparatus that is marked in step S608 and is not registered yet. When the environment setting application 112 determines that there remains a printing apparatus (YES in step S612), the process in step S609 is performed. When the environment setting application 112 determines that there remains no printing apparatus (NO in step S612), in step S613, the search and registration processing ends.

As described above, when a printing apparatus to be used is registered, a request from the client application 105 to the print control system is enabled.

The client application 105 is, upon its start-up, connected to the interface module 106. The client application 105 works together with the interface module 106 to establish communication therebetween through an interface provided by the OS running on the PC1 (101). In the present exemplary embodiment, a Component Object Model (COM) interface by Windows® is used.

The client application 105 generates an instance to identify itself using API provided by the interface module 106, and obtains an identifier of the application 105 (i.e., a client identifier).

Thereafter, at every invoking of API, the print control system (i.e., each module therein) can be notified that the client application 105 is the source of the request, through specification of the client identifier.

The client application 105 registers an event receiving object for call-back to receive various statuses of a printing apparatus and error notifications from the print control system. The event receiving object is registered using API that includes a predetermined interface to register the event receiving object (i.e., event receiving object registration API).

When the above preparation is completed, the client application 105 uses API that enables acquisition of information of printing apparatuses, to acquire information of the printing apparatuses registered to the print control system. As the information of the printing apparatus, a list of information of printing apparatuses is returned to the client application 105 from the printing apparatus management module 107.

After acquisition of the information of the printing apparatuses, the client application 105 receives an operation by a user to select a printing apparatus to be used with the client application 105 from the printing apparatuses in the information. The client application 105 then obtains a printing apparatus identifier corresponding to the selected printing apparatus.

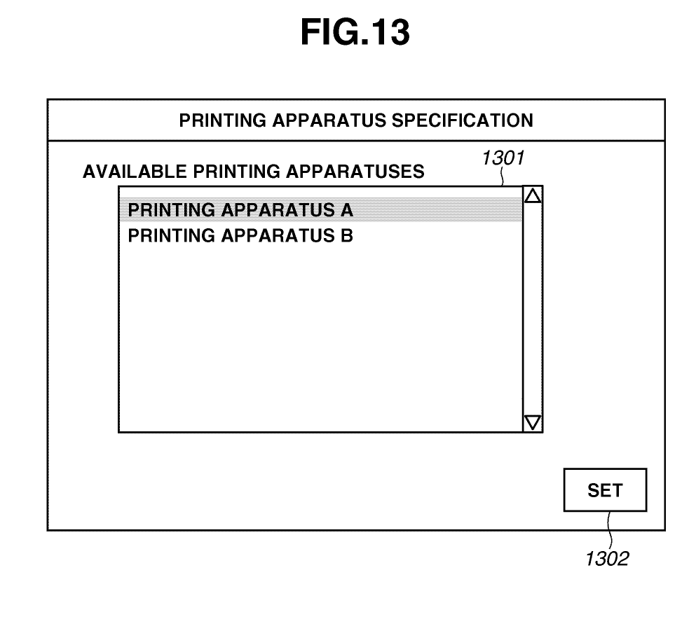

FIG. 13 illustrates an example of a screen (printing apparatus specifying screen) displayed by the client application 105 and through which the client application 105 receives an operation by a user to select a printing apparatus to be used. A user selects a printing apparatus to be used from the printing apparatus list area 1301, and presses a setting button 1302 on the printing apparatus specifying screen.

The client application 105 invokes API that generates a printing apparatus instance using, as an argument, the printing apparatus identifier corresponding to the printing apparatus selected by the user, and obtains an identifier of the generated printing apparatus instance. Thereafter, at every invoking of API, a target printing apparatus for a process using the API can be specified through specification of the identifier of the printing apparatus instance (i.e., a printing apparatus instance identifier).

The printing apparatus instance is generated by the printing apparatus management module 107, and is managed in association with a corresponding printing apparatus identifier. At invoking of API, a printing apparatus instance identifier is specified, and the identifier is replaced with a printing apparatus identifier by the printing apparatus management module 107 to execute subsequent processes.

The client application 105 registers a path that indicates a status (i.e., a status path) using API (i.e., API for status path registration), when a notification is required about the status of a specific printing apparatus or any change in the status of a print job performed in a specific printing apparatus.

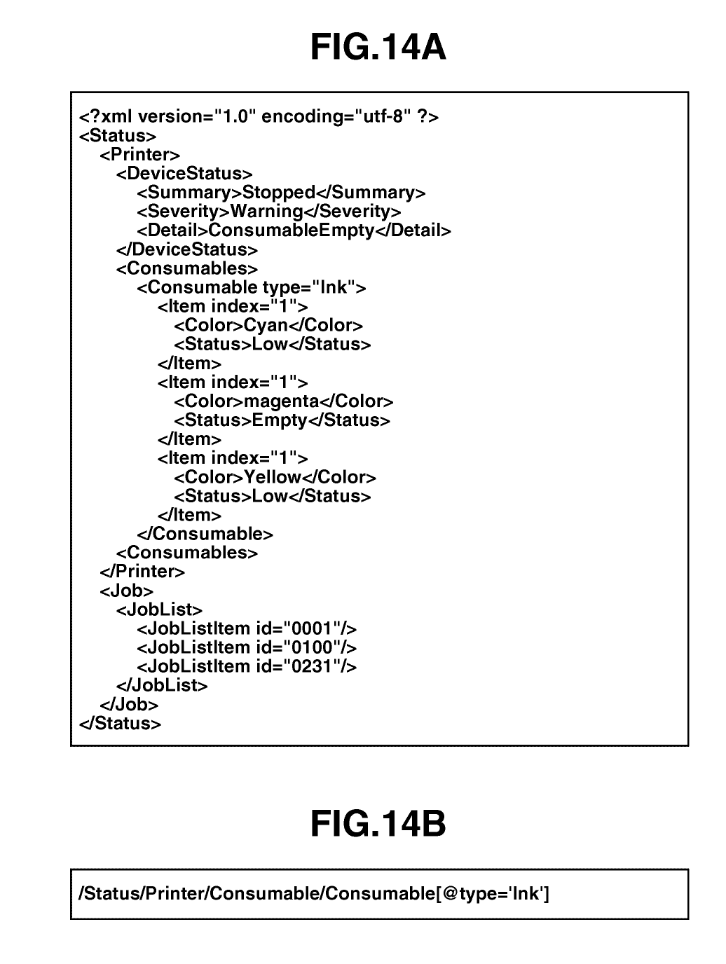

FIG. 14A illustrates an example of status information that is used to manage the status of each printing apparatus by a printing apparatus control module. The status information is stored in the hard disk 210 as data in an Extensible Markup Language (XML) format. A status path can be specified by a notation based on an XPath (XML Path Language) to specify a status to be notified among the status information.

FIG. 14B illustrates an example of a description for a status path. For example, the nodes except the leaf node can be specified among the nodes in the status information in FIG. 14A, to specify all of the child nodes thereof.

When the client application 105 invokes a status path registration API, registration of a status path is requested to the printing apparatus management module 107 through the interface module 106. The printing apparatus management module 107, upon receipt of the request, registers information to the status path management table. The information contains the client identifier, printing apparatus identifier, and status path with associated with one another.

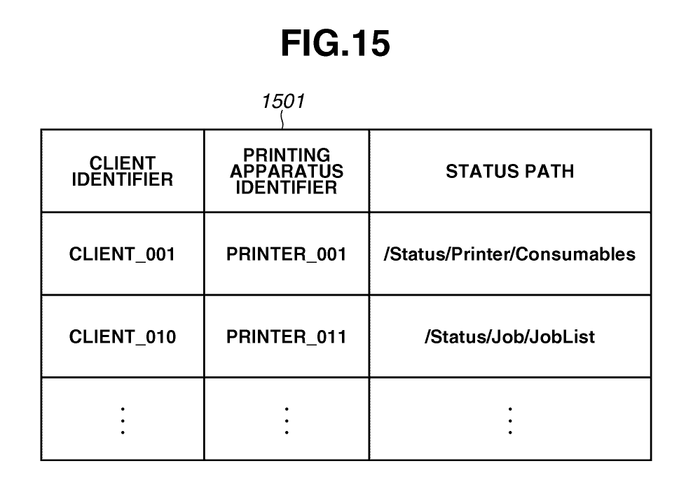

FIG. 15 illustrates an example of a status path management table (a status path management table 1501) stored in the hard disk 210 of the PC2 (102).

The printing apparatus management module 107 then obtains the name of a printing apparatus control module that controls the printing apparatus corresponding to a printing apparatus identifier, from the printing apparatus management table 1001 and the printing apparatus control module management table 1101.

The printing apparatus management module 107 specifies a printing apparatus identifier and a status path, and requests registration of the status path to the printing apparatus control module (e.g., the printing apparatus control module A 108) corresponding to the obtained printing apparatus control module name.

The printing apparatus control module A 108, upon receipt of the request for status path registration, registers the printing apparatus identifier and the status path in its own status path management table.

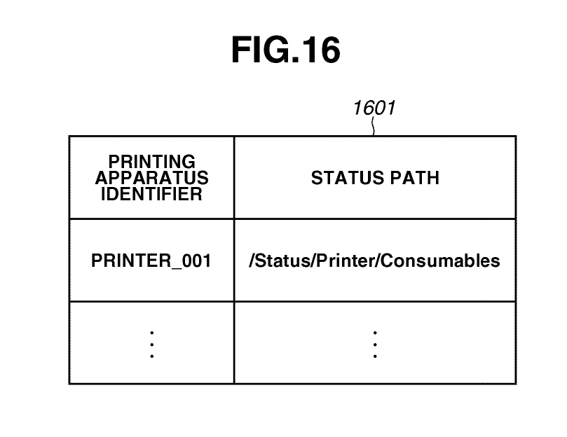

FIG. 16 illustrates an example of a status path management table (a status path management table 1601) stored in the hard disk 210 of the PC3 (103). In the present exemplary embodiment, the printing apparatus control module A 108 is used as an example, but the same process is performed on the printing apparatus control module B 110.

When a change occurs in the status corresponding to the status path registered in the printing apparatus A 109, the printing apparatus A 109 notifies the printing apparatus control module A 108 of the change in status (change notification). Upon receipt of the change notification about the status of the printing apparatus A 109, the printing apparatus control module A 108 updates the value of a corresponding node (node value) in the status information for the printing apparatus A 109.

The printing apparatus control module A 108 then refers to the status path management table 1601, and determines whether to notify the printing apparatus management module 107 of the change in status information.

The printing apparatus control module A 108 notifies the printing apparatus management module 107 of the status path and the node value for the status path, when the status path corresponding to the changed status is contained in the status path management table 1601.

The printing apparatus control module A 108 notifies the printing apparatus management module 107 of the value of a leaf node as a node value when the status path indicates the leaf node. Otherwise, the printing apparatus control module A 108 notifies NULL as the node value to the printing apparatus management module 107.

The printing apparatus management module 107 first searches the status path management table 1501 for the client identifier of the client application by which the notified status path is registered.

The printing apparatus management module 107 then notifies the interface module 106 of the status path and the node value. The interface module 106 is connected to the client application 105 corresponding to the searched client identifier.

The interface module 106, upon receipt of the notification, notifies an event receiving object corresponding to the client application 105 of the status path and the node value. The client application 105, upon receipt of the notification, obtains a status (e.g., a node value) corresponding to the status path, and performs processing such as updating of screen display.

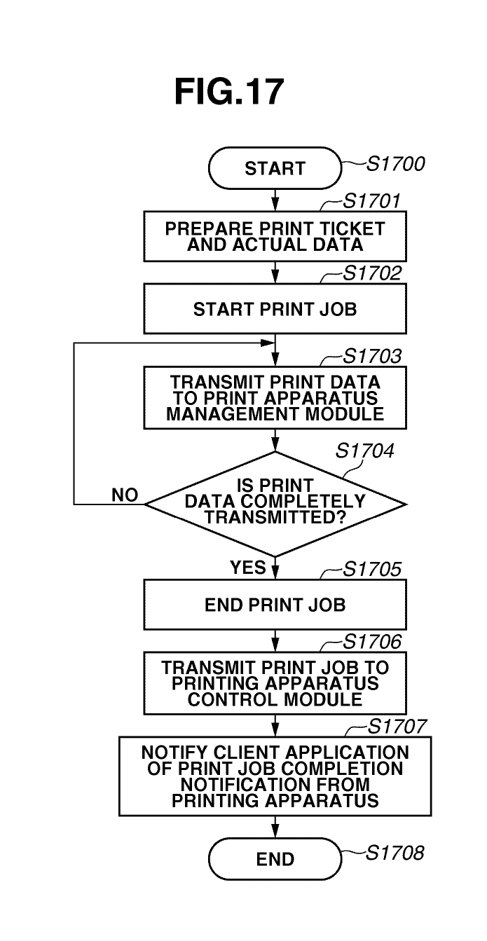

FIG. 17 illustrates an example of a flowchart for a printing processing program to execute print jobs.

In step S1700, printing processing starts. In step S1701, the client application 105 prepares job data that is an example of job information constituting the print job. The job data includes a ticket and actual data. The ticket has descriptions of a configuration of the print job, print setting information of each page, and the name of the actual data (i.e., information that instructs reference to the actual data). The actual data may be image data such as Joint Photographic Experts Group (JPEG) and a page description language (PDL) file, for example.

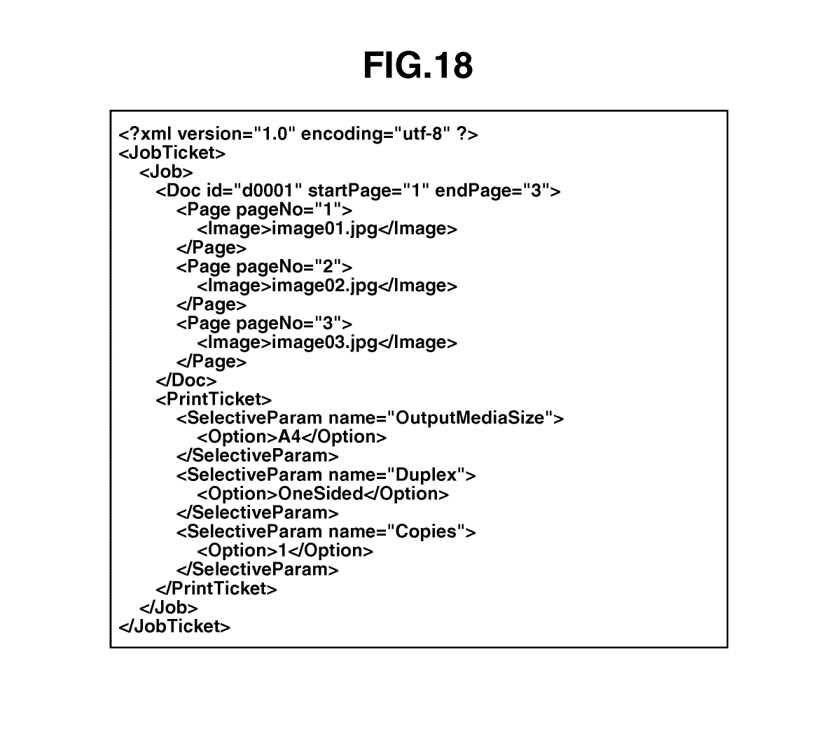

FIG. 18 illustrates an example of a ticket to be used in the print control system. The ticket is described in an XML format. The ticket has a JobTicket node as a route node. The JobTicket node has Doc node that describes the structure of print data and PrintTicket node that specifies print setting information, as its child nodes.

The PrintTicket node has a configuration to which an additional description of print setting information can be added. The Doc node includes a Page node that represents pages of the print data, as its child node. The Page node has a page number as its attribute, and specifies contents of a page as a child node.

In the ticket illustrated in FIG. 18, a JPEG file is specified as contents of each page. At the PrintTicket node in FIG. 18, parameters and setting values of print setting information are specified. The attributes “OutputMedia Size”, “Duplex”, and “Copies” are specified as “A4”, “OneSided”, and “1” respectively.

In step S1702, the client application 105 starts the print job. More specifically, the client application 105 invokes API that starts the print job (print job starting API). Through the print job starting API, a client identifier, a printing apparatus identifier, and a ticket are specified as input information, and a job identifier is obtained as output information.

The invoking of the print job starting API is synchronously processed to the printing apparatus control module A 108 or the printing apparatus control module B 110 through the printing apparatus management module 107.

In step S1703, the client application 105 transfers print data to the printing apparatus management module 107. More specifically, the client application 105 invokes API for print data transmission (print data transmission API). Through the print data transmission API, a client identifier, a printing apparatus identifier, a job identifier, an actual data buffer, an actual data size are specified as input information.

The request through the print data transmission API is managed using a request queue, in the printing apparatus management module 107, for every printing apparatus that is the transfer destination of the print data. The invoking of print data transmission API from the client application 105 terminates when the print data is transferred to the printing apparatus management module 107 (i.e., at the end of the transfer).

In step S1704, the client application 105 determines whether all of the data required for the print job is completely transferred. When the client application 105 determines that the data is completely transferred (YES in step S1704), the processing in step S1705 is performed. When the client application 105 determines that the data is not completely transferred yet (NO in step S1704), the processing in step S1703 is performed.

In step S1705, the client application 105 ends the print job. More specifically, the client application 105 invokes API for ending the print job (print job ending API). Through the print job ending API, a client identifier, a printing apparatus identifier, and a job identifier are specified as input information.

The invoking of the print job ending API is managed in the printing apparatus management module 107 for every printing apparatus as a destination of the print data, according to queue. The invoking of the print job ending API from the client application 105 terminates when requests to the printing apparatus management module 107 are completed.

In step S1706, the printing apparatus management module 107 transmits requests (e.g., print job) to the printing apparatus control modules. More specifically, the printing apparatus management module 107 transmits requests to corresponding printing apparatus control modules in sequence, the requests that are accumulated in request queue for each printing apparatus.

More specifically, first, the printing apparatus management module 107 refers to the printing apparatus management table 1001, and reads the type of the printing apparatus corresponding to the received printing apparatus identifier.

The printing apparatus management module 107 refers to the printing apparatus control module management table 1101, determines a printing apparatus control module name (i.e., the printing apparatus control module A 108) that corresponds to the read printing apparatus type, and transmits a request thereof to the printing apparatus control module A 108.

In the present exemplary embodiment, two tables are used to make printing apparatus identifiers, types of printing apparatuses, and printing apparatus control module names associated to one another, but the association may be configured otherwise.

The printing apparatus control module A 108 processes the transmitted request, and performs printing using the printing apparatus A 109.

In the present exemplary embodiment, the processing in step S1706 is performed after the request for a print job is completely transmitted to the printing apparatus management module 107, but the order of the steps may be configured otherwise. For example, in step S1703, after the time point when a request is added to a request queue at the printing apparatus management module 107, the processing in step S1706 may be executed in parallel to the processing in step S1703 to step S1705.

In step S1707, the printing apparatus control module A 108 receives a notification indicating that the print job is completed from the printing apparatus A 109 (print job completion notification), and notifies the client application 105 through the modules 106 and 107 of the print job completion. In step S1708, the print process ends.

Accommodation of difference in functions between types of printing apparatuses each transmit a print job at issue of the print job is described.

FIG. 18 illustrates a ticket that is used by the printing apparatus A 109, but the ticket can be used by the other printing apparatuses having the similar functions. When the other printing apparatuses have a finisher (i.e., another function) that is a function the printing apparatus A 109 does not have, in conventional methods, additional description to a print data format is required to support the finisher.

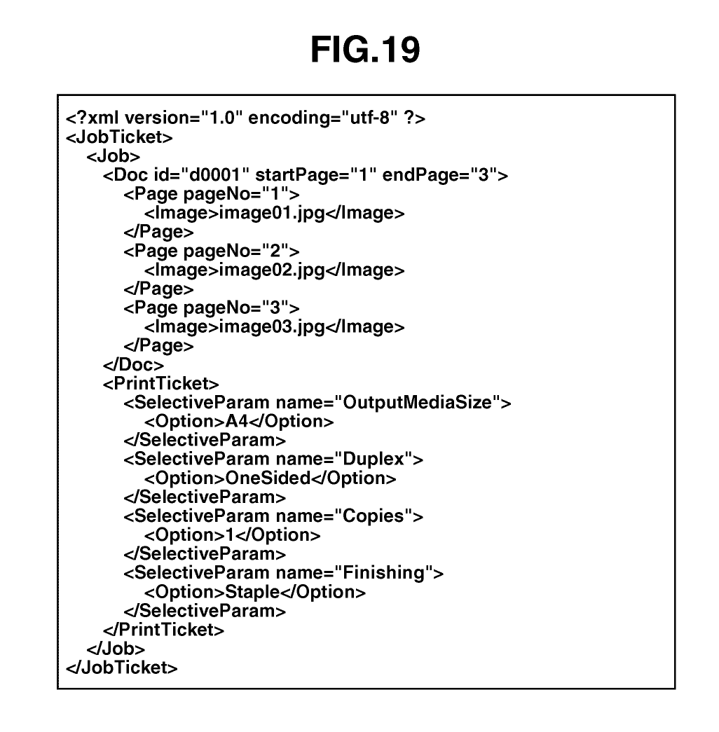

On the other hand, in the print control system, as illustrated in the ticket in FIG. 19, only additional description of “Finishing” option and “Staple” as the value of the option is required, and no change in the other modules is necessary to use the other functions of the other printing apparatuses.

In the present exemplary embodiment, after issuing a print job, API for controlling the print job (print job control API) may be used to control the print job. Through the print job control API, a client identifier, a printing apparatus identifier, a job identifier, a control mode are specified as input information. Examples of the control mode include “cancel” and “delete”.

Through the print job control API, as well as the print job issued through the client application 105 itself, a print job issued through another client application or a printer driver for another printing apparatus can be controlled by specifying the job identifier of the print job.

The job identifier of the print job issued through another application or driver other than the client application 105 is obtained as follows.

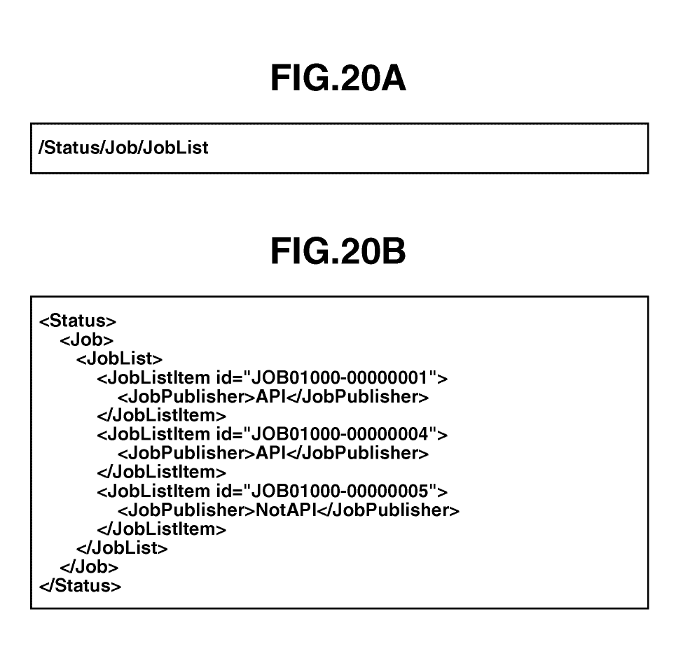

The client application 105 obtains a list of print job information in a printing apparatus, through API for obtaining a status path (status obtaining API). Through the status obtaining API, a client identifier, a printing apparatus identifier, and a status path are specified as input information. The status path is specified as illustrated in FIG. 20A. FIG. 20B illustrates an example of data obtained when the status obtaining API is invoked with the status path specification in FIG. 20A.

A case where a job identifier of a print job issued through the client application 105 is “JOB01000-00000001”, is described.

In FIG. 20B, among the child nodes JobPublisher of the three JobListItem nodes in JobList, the child nodes having the value of “API” represent print jobs issued using the print control system. The child node having the value of “NotAPI” represents a print job issued without using the present print control system.

Among the three JobListItem nodes, the node having the attribute id of “JOB01000-00000001” corresponds to a print job issued through the client application 105. The node having the attribute id of “JOB01000-00000004” corresponds to a print job issued using the present print control system through a client application other than the client application 105.

In the above case, the third JobListItem node having the attribute id of “JOB01000-00000005” is the identifier of a print job issued from other than the present print control system.

According to the above configuration, only addition description to a ticket having print setting information enables support of a printer having a new function, without the necessity of changing print data or procedure for printing, which causes no adverse affect on the other parts of the print control system.

In addition, printing fully using the features of a printer can be easily controlled through combination of different tickets in one print data.

Furthermore, a new printer can be handled by adding a printing apparatus control module corresponding to the printer, without modification of the other modules, and by setting connection setting information between modules in the system using an environment setting application.

Between printers of different types, common processing of a client application can be shared through a common mechanism for event distribution.

The present exemplary embodiment is not limited to the above configuration. For example, among a plurality of printing apparatus control modules, those having relatively high load may be incorporated in the other PCs. In this case, loads applied to PCs can be easily balanced among the PCs, through the distribution of the printing apparatus control modules having relatively high load to the other PCs.

In a print control system of the present exemplary embodiment, the printing apparatus management module 107, the printing apparatus control module A 108, and the printing apparatus control module B 110 are incorporated in one PC.

In the case of the system having the above configuration, actual print data is not transferred from the printing apparatus management module 107 to the printing apparatus control modules (108, 110), but is stored as a file by the printing apparatus management module 107.

A path of the print data is notified to the printing apparatus control modules 108 and 110, so that the printing apparatus control modules individually read the print data from the file. The configuration can reduce the load for transfer, and increases the processing efficiency.

The configurations in the above exemplary embodiments can facilitate printing at a new printer.

While the exemplary embodiments of the present invention have been described, the present invention is not limited to these exemplary embodiments, and various changes and modifications can be made within the scope of the present invention as claimed.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-279500 filed Dec. 15, 2010, which is hereby incorporated by reference herein in its entirety.

What is claimed is:

1. An information processing apparatus, comprising:
a storage unit having a storage device, configured to obtain, from a control unit, identification information for identifying an image forming apparatus connected to the control unit and model information that indicates a model of the image forming apparatus, and to store the identification information and the model information in association with control unit identification information that identifies the control unit, into the storage device, wherein the control unit controls printing of print data;
a receiving unit configured to receive the print data and the identification information from an interface unit, wherein an application unit generates job information in a format in which print setting information indicating a setting item of the image forming apparatus for printing the print data and a value of the setting item can be added, and to request for transmission of the print data and the identification information of the image forming apparatus, wherein the interface unit transmits, upon receiving the request, the print data and the identification information of the image forming apparatus therethrough; and
a determination unit configured to read out, from the storage device, the control unit identification information that is associated with the identification information, and received by the receiving unit, and to determine the control unit identified by the control unit identification information as a control unit to be specified to control printing of the print data.

2. The information processing apparatus according to claim 1, further comprising a notification unit configured to notify the control unit of information about a path of the print data;
wherein the control unit is incorporated in the information processing apparatus.

3. The information processing apparatus according to claim 1, further comprising a transmission unit configured to transmit the print data to the control unit; and
wherein the control unit is incorporated in another information processing apparatus other than the information processing apparatus.

4. The information processing apparatus according to claim 1, wherein the interface unit is incorporated in another information processing apparatus other than the information processing apparatus.

5. The information processing apparatus according to claim 1, wherein the job information contains information for referring to the print data.

6. A printing control method, comprising:
obtaining, from a control unit configured to control printing of print data, identification information that identifies an image forming apparatus connected to the control unit and model information that indicates a model of the image forming apparatus;
storing the identification information and the model information in association with control unit identification information for identifying the control unit into a storage device;
receiving the print data and the identification information from an interface unit configured to transmit the print data and the identification information of the image forming apparatus therethrough in response to a request from an application unit configured to generate job information in a format in which print setting information indicating a setting item of the image forming apparatus and a value of the setting item can be added; and
reading out, from the storage device, the received control unit identification information in association with the identification information, and
determining the control unit identified by the control unit identification information as a control unit to be specified to control printing of the print data.

7. A non-transitory computer-readable storage medium storing a program to execute a printing control method, the control method comprising:
obtaining, from a control unit configured to control printing of print data, identification information that identifies an image forming apparatus connected to the control unit and model information that indicates a model of the image forming apparatus;
storing the identification information and the model information in association with control unit identification information for identifying the control unit into a storage device;
receiving the print data and the identification information from an interface unit configured to transmit the print data and the identification information of the image forming apparatus therethrough in response to a request from an application unit configured to generate job information in a format in which print setting information indicating a setting item of the image forming apparatus and a value of the setting item can be added; and
reading out, from the storage device, the received control unit identification information in association with the identification information, and
determining the control unit identified by the control unit identification information as a control unit to be specified to control printing of the print data.
